(19) United States
(12) Patent Application Publication
(10) Pub. No.: US 2018/0050517 A1
(43) Pub. Date: Feb. 22, 2018

(54) ADHESIVE REINFORCING SHEET, SLIDING MEMBER AND METHOD FOR PRODUCING ADHESIVE REINFORCING SHEET

(71) Applicant: SUMITOMO ELECTRIC FINE POLYMER, INC., Sennan-gun, Osaka (JP)

(72) Inventors: Hong-Phuc NGUYEN, Osaka (JP); Kazuaki IKEDA, Osaka (JP)

(73) Assignee: SUMITOMO ELECTRIC FINE POLYMER, INC., Sennan-gun, Osaka (JP)

(21) Appl. No.: 15/560,211

(22) PCT Filed: Feb. 9, 2016
(86) PCT No.: PCT/JP2016/053811

§ 371 Date: Sep. 21, 2017

(30) Foreign Application Priority Data
May 14, 2015 (JP) 2015-099425

(51) Int. Cl. B32B 15/082; B29C 65/14; B32B 7/10; B32B 27/30; B32B 27/08; C09J 7/02

(52) U.S. Cl. CPC B32B 15/082; B29C 65/14; B32B 7/10; C09J 2471/006; B32B 27/08; C09J 7/02; B32B 27/30

(57) ABSTRACT

An adhesive reinforcing sheet according to an embodiment of the present invention includes a surface layer containing a crosslinked fluororesin as a main component, an intermediate layer laminated on one of surfaces of the surface layer and containing a metal or a super engineering plastic as a main component, and an adhesive layer laminated on a surface of the intermediate layer, the surface being opposite to the surface layer. In the adhesive reinforcing sheet, the crosslinked fluororesin is chemically bonded to the intermediate layer. The intermediate layer may contain aluminum, stainless steel, or iron as the main component. The intermediate layer may contain a polyimide, a polyamide-imide, or a combination of a polyimide and a polyamide-imide as the main component.

### TECHNICAL FIELD

The present invention relates to an adhesive reinforcing sheet, a sliding member, and a method for producing an adhesive reinforcing sheet.

### BACKGROUND ART

Fluororesins have good heat resistance, chemical resistance, and weather resistance, have low tackiness and low coefficients of friction, and have good sliding properties. Therefore, fluororesins are considered to be useful as a coating of various bases and sliding members. However, adhesive strength between fluororesins and bases easily decreases due to the low surface free energy of the fluororesins. Accordingly, in the case where fluororesins are used as a coating of members, the fluororesins become easily detached from the bases. In addition, fluororesins have relatively low abrasion resistance and thermal conductivity. Accordingly, in the case where fluororesins are used for sliding members, surfaces of the sliding members are easily worn, and abrasion is particularly accelerated by an increase in the temperature of the sliding surfaces due to continuous operation.

On the other hand, when a base is coated with a fluororesin and is irradiated with an ionizing radiation in a low-oxygen atmosphere at a temperature equal to or higher than the crystalline melting point of the fluororesin, molecules of the fluororesin are crosslinked to improve abrasion resistance. In addition, when a region where a fluororesin is in contact with a base is irradiated with an ionizing radiation, a chemical bond is formed between the fluororesin and the base in the region to improve adhesive strength.

As an example of utilization of such properties of fluororesins, a sliding member including a surface layer that is formed of a crosslinked fluororesin and a radiator that is in close contact with the surface layer has been proposed (refer to Japanese Unexamined Patent Application Publication No. 2014-109292). This sliding member is configured so that frictional heat generated during sliding is dissipated by the radiator in close contact with the surface layer. Therefore, the sliding member is considered to have good heat dissipation properties while utilizing good sliding properties etc. of the crosslinked fluororesin. Furthermore, the sliding member is considered to have good adhesive strength between the fluororesin and the radiator because the fluororesin and the radiator are irradiated with an ionizing radiation at the same time.

### CITATION LIST

### Patent Literature

PTL 1: Japanese Unexamined Patent Application Publication No. 2014-109292

### SUMMARY OF INVENTION

### Technical Problem

However, when an ionizing radiation is applied, for example, irradiation equipment for applying the ionizing radiation is necessary, and the process becomes complex. In addition, since the ionizing radiation is applied at a temperature equal to or higher than the crystalline melting point of the fluororesin (for example, 340° C. or higher), the base may be deformed. Furthermore, when the base is a member that has been quenched for the purpose of, for example, improving strength, tempering may be caused by heating to the temperature equal to or higher than the crystalline melting point, and the heat-treatment effect may decrease.

Another conceivable method includes using an adhesive reinforcing sheet that includes a surface layer containing a crosslinked fluororesin as a main component and an adhesive layer laminated on one of the surfaces of the surface layer. The surface layer of this adhesive reinforcing sheet can be attached to a surface of a base with the adhesive layer therebetween. However, fluororesins have low adhesive strength to other resins. Therefore, the adhesive reinforcing sheet described above has a disadvantage that the attached surface layer becomes easily detached due to low adhesive strength between the surface layer and the adhesive layer.

The present invention has been made in view of the circumstances described above. An object of the present invention is to provide an adhesive reinforcing sheet with which a surface layer containing a crosslinked fluororesin as a main component can be easily and reliably attached to an object of attachment.

### Solution to Problem

An adhesive reinforcing sheet according to an embodiment of the present invention, which has been made to solve the problems described above, includes a surface layer containing a crosslinked fluororesin as a main component, an intermediate layer laminated on one of surfaces of the surface layer and containing a metal or a super engineering plastic as a main component, and an adhesive layer laminated on a surface of the intermediate layer, the surface being opposite to the surface layer. In the adhesive reinforcing sheet, the crosslinked fluororesin is chemically bonded to the intermediate layer.

A sliding member according to another embodiment of the present invention, which has been made to solve the problems described above, has a sliding surface that has the adhesive reinforcing sheet attached to at least a part thereof.

A method for producing an adhesive reinforcing sheet according to still another embodiment of the present invention, which has been made to solve the problems described above, includes a step of laminating an intermediate layer containing a metal or a super engineering plastic as a main component on one of surfaces of a surface layer containing a fluororesin as a main component; a step of, after the intermediate layer lamination step, irradiating the surface layer with an ionizing radiation in a low-oxygen atmosphere at a temperature equal to or higher than a crystalline melting point of the fluororesin; and a step of, after the ionizing radiation irradiation step, laminating an adhesive layer on a surface of the intermediate layer, the surface being opposite to the surface layer. In the ionizing radiation irradiation step, the fluororesin is crosslinked, and the fluororesin and the intermediate layer are chemically bonded to each other.

Herein, the term “super engineering plastic” refers to a synthetic resin having a long-term heat resistance of 100° C. or more, a heat distortion temperature of 150° C. or higher, a tensile strength of 5 kgf·mm⁻² or more, and a flexural modulus of elasticity of 245 kgf·mm⁻² or more. However, synthetic resins containing a fluororesin as a main component are not included. The term “main component” refers to a component having the highest content and refers to a component having a content of, for example, 50% by mass or more. The term “adhesive layer” refers to a layer containing an adhesive or a pressure-sensitive adhesive as the main component. The term “chemical bond” refers to a concept including a hydrogen bond, a coordination bond, and a van der Waals bond in addition to a covalent bond, an ionic bond, and a metallic bond. The term “crystalline melting point” refers to a melting point peak temperature measured in accordance with JIS-K7121:2012 “Testing methods for transition temperatures of plastics” using a differential scanning calorimeter (DSC).

### Advantageous Effects of Invention

The adhesive reinforcing sheet according to an embodiment of the present invention and a method for producing the adhesive reinforcing sheet can provide an adhesive reinforcing sheet with which a surface layer containing a crosslinked fluororesin as a main component can be easily and reliably attached to an object of attachment. A sliding member according to another embodiment of the present invention has a surface layer that contains a fluororesin as a main component and that is unlikely to become detached, and can be produced at a low cost.

### BRIEF DESCRIPTION OF DRAWING

FIG. 1 is a schematic sectional view illustrating an adhesive reinforcing sheet according to an embodiment of the present invention.

### DESCRIPTION OF EMBODIMENTS

### Description of Embodiments of the Present Invention

An adhesive reinforcing sheet according to an embodiment of the present invention includes a surface layer containing a crosslinked fluororesin as a main component, an intermediate layer laminated on one of surfaces of the surface layer and containing a metal or a super engineering plastic as a main component, and an adhesive layer laminated on a surface of the intermediate layer, the surface being opposite to the surface layer. In the adhesive reinforcing sheet, the crosslinked fluororesin is chemically bonded to the intermediate layer.

The adhesive reinforcing sheet includes a surface layer containing a crosslinked fluororesin as a main component. Accordingly, when the adhesive reinforcing sheet is attached to an object of attachment, such as a sliding member, chemical resistance, weather resistance, abrasion resistance, and the like of the surface of the object of attachment can be improved and tackiness and the coefficient of friction can be decreased. Furthermore, in the adhesive reinforcing sheet, since the crosslinked fluororesin is chemically bonded to an intermediate layer, the adhesive reinforcing sheet has good interlayer adhesive strength between the surface layer and the intermediate layer. Therefore, the surface layer of the attached adhesive reinforcing sheet adheres onto the object of attachment with the intermediate layer and the adhesive layer therebetween, and thus the surface layer is unlikely to become detached. Furthermore, a metal or a super engineering plastic serving as a main component of the intermediate layer can suppress deformation or the like due to heating or irradiation with an ionizing radiation during crosslinking of the fluororesin. Furthermore, even when the object of attachment is a member that has been quenched for the purpose of, for example, improving strength, a decrease in the heat-treatment effect due to tempering can be suppressed. As described above, in the adhesive reinforcing sheet, the surface layer containing a crosslinked fluororesin as a main component can be easily and reliably attached to an object of attachment.

The intermediate layer preferably contains a metal as the main component, and the metal is preferably aluminum, stainless steel, or iron. Aluminum, stainless steel, or iron is relatively cheap, has good ductility and heat resistance, and easily forms a chemical bond with a crosslinked fluororesin. Accordingly, when the intermediate layer contains a metal as the main component, and the metal is aluminum, stainless steel, or iron, the surface layer is still less likely to become detached, and a reduction in the production cost and an improvement in flexibility of the intermediate layer can be achieved in a balanced manner.

The intermediate layer preferably contains a super engineering plastic as the main component, and the super engineering plastic is preferably a polyimide, a polyamide-imide, or a combination of a polyimide and a polyamide-imide. Polyimides and polyamide-imides are relatively lightweight and have good flexibility and heat resistance. Accordingly, when the intermediate layer contains a super engineering plastic as the main component, and the super engineering plastic is a polyimide, a polyamide-imide, or a combination of a polyimide and a polyamide-imide, flexibility of the intermediate layer can be improved and a reduction in the weight can be realized.

The surface layer preferably has an average thickness of 10 μm or more and 1,500 μm or less. The intermediate layer preferably has an average thickness of 0.1 μm or more and 2,000 μm or less. When the average thickness of the surface layer is in the above range, durability and properties of the crosslinked fluororesin can be easily exerted in a balanced manner. In addition, when the average thickness of the intermediate layer is in the above range, that is, when the intermediate layer has a relatively small thickness, flexibility of the intermediate layer can be improved. As a result, the adhesive reinforcing sheet can also be easily and reliably attached to an object of attachment having a curved surface. Herein, the term “average thickness” refers to an average of thicknesses measured at arbitrary ten points.

The adhesive reinforcing sheet can be suitably used for attachment to a sliding surface of a sliding member. The attachment of the adhesive reinforcing sheet enables abrasion resistance of a sliding surface of a sliding member to improve and enables tackiness and the coefficient of friction to decrease.

A sliding member according to another embodiment of the present invention has a sliding surface that has the adhesive reinforcing sheet attached to at least a part thereof. Since the adhesive reinforcing sheet is attached to at least a part of the sliding surface, the sliding member has good abrasion resistance, low tackiness, and a low coefficient of friction, and thus has good sliding properties.

A method for producing an adhesive reinforcing sheet according to still another embodiment of the present invention includes a step of laminating an intermediate layer containing a metal or a super engineering plastic as a main component on one of surfaces of a surface layer containing a fluororesin as a main component; a step of, after the intermediate layer lamination step, irradiating the surface layer with an ionizing radiation in a low-oxygen atmosphere at a temperature equal to or higher than a crystalline melting point of the fluororesin; and a step of, after the ionizing radiation irradiation step, laminating an adhesive layer on a surface of the intermediate layer, the surface being opposite to the surface layer. In the ionizing radiation irradiation step, the fluororesin is crosslinked, and the fluororesin and the intermediate layer are chemically bonded to each other.

The method for producing an adhesive reinforcing sheet can provide an adhesive reinforcing sheet with which a surface layer containing a crosslinked fluororesin as a main component can be easily and reliably attached to an object of attachment.

### DETAILS OF EMBODIMENTS OF THE PRESENT INVENTION

Hereinafter, an adhesive reinforcing sheet, a method for producing the adhesive reinforcing sheet, and a sliding member according to embodiments of the present invention will be described in detail with reference to the drawing.

### First Embodiment

### <Adhesive Reinforcing Sheet>

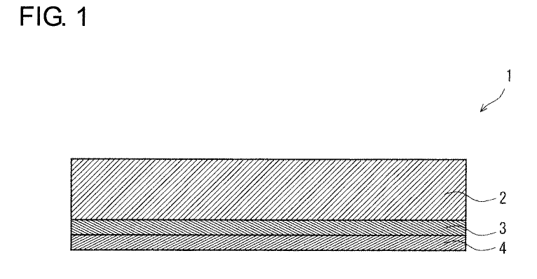

An adhesive reinforcing sheet 1 illustrated in FIG. 1 includes a surface layer 2, an intermediate layer 3 laminated on one of the surfaces of the surface layer 2, and an adhesive layer 4 laminated on a surface of the intermediate layer 3, the surface being opposite to the surface layer 2.

The planar shape of the adhesive reinforcing sheet 1 is not particularly limited and may be appropriately changed depending on use or the like. The lower limit of the average thickness of the adhesive reinforcing sheet 1 is not particularly limited but is, for example, 40 μm. The upper limit of the average thickness is not particularly limited but is, for example, 2,500 μm.

### (Surface Layer)

The surface layer 2 contains a crosslinked fluororesin as a main component. The surface layer 2 covers a surface of an object of attachment to which the adhesive reinforcing sheet 1 is attached, and provides the object of attachment with properties of the crosslinked fluororesin, such as heat resistance. This crosslinked fluororesin is chemically bonded to the intermediate layer 3, which will be described later. The surface layer 2 may contain any other optional components within a range that does not impair the advantages of the present invention.

The lower limit of the average thickness of the surface layer 2 is preferably 10 μm, more preferably 20 μm, and still more preferably 40 μm. The upper limit of the average thickness is preferably 1,500 μm, more preferably 500 μm, still more preferably 200 μm, and particularly preferably 60 μm. When the average thickness is less than the lower limit, durability of the adhesive reinforcing sheet 1 may decrease. In contrast, when the average thickness is more than the upper limit, flexibility of the adhesive reinforcing sheet 1 may decrease. Furthermore, in the case where the adhesive reinforcing sheet 1 is used for attachment to a sliding surface of a sliding member, it may become difficult to dissipate frictional heat generated during sliding.

The crosslinked fluororesin is obtained by applying an ionizing radiation to a fluororesin. Herein, the term “fluororesin” refers to a resin in which at least one hydrogen atom bonded to a carbon atom that forms a polymerization unit of a polymer chain is substituted with a fluorine atom or an organic group having a fluorine atom (hereinafter, may be referred to as “fluorine atom-containing group”). The fluorine atom-containing group is a group in which at least one hydrogen atom in a linear or branched organic group is substituted with a fluorine atom. Examples of the fluorine atom-containing group include fluoroalkyl groups, fluoroalkoxy groups, and fluoropolyether groups.

Examples of the fluororesin include polytetrafluoroethylene (PTFE), tetrafluoroethylene-perfluoroalkyl vinyl ether copolymers (PFA), tetrafluoroethylene-hexafluoropropylene copolymers (FEP), polyvinylidene fluoride (PVDF), tetrafluoroethylene-ethylene copolymers (ETFE), polychlorotrifluoroethylene (PCTFE), chlorotrifluoroethylene-ethylene copolymerization (ECTFE), polyvinyl fluoride (PVF), fluoroolefin-vinyl ether copolymers, vinylidene fluoride-tetrafluoroethylene copolymers, and vinylidene fluoride-hexafluoropropylene copolymers. Of these, as the fluororesin, PTFE, PFA, and FEP are preferable, PFA and PTFE are more preferable, and PTFE is still more preferable from the viewpoint of mechanical strength, chemical resistance, and heat resistance. The above fluororesins may be used alone or in combination of two or more resins.

The fluororesin may contain a polymerization unit derived from another copolymerizable monomer within a range that does not impair the advantages of the present invention. For example, PTFE may contain a polymerization unit such as perfluoro(alkyl vinyl ether), hexafluoropropylene, (perfluoroalkyl)ethylene, or chlorotrifluoroethylene. The upper limit of the content of the polymerization unit derived from the other copolymerizable monomer is, for example, 3% by mole relative to the total polymerization units constituting the fluororesin.

The lower limit of the content of the crosslinked fluororesin in the surface layer 2 is preferably 60% by mass, more preferably 85% by mass, and still more preferably 98% by mass. The content is particularly preferably 100% by mass. When the content is less than the lower limit, the object of attachment to which the adhesive reinforcing sheet 1 is attached may not be sufficiently provided with properties such as heat resistance.

The upper limit of the crystalline melting point temperature of the crosslinked fluororesin in the surface layer 2 varies depending on the type of fluororesin. However, for example, in the case of PTFE, the upper limit of the crystalline melting point temperature is preferably 325° C., more preferably 320° C., and still more preferably 310° C. The crystalline melting point temperature decreases with an increase in the degree of crosslinking of the crosslinked fluororesin. Therefore, when the crystalline melting point temperature is more than the upper limit, abrasion resistance may become insufficient due to insufficient degree of crosslinking. The lower limit of the crystalline melting point temperature of the crosslinked fluororesin is, for example, 290° C. When the crystalline melting point temperature is less than the lower limit, abrasion resistance may become insufficient due to a decrease in heat resistance or the like.

Examples of the other optional components which may be contained in the surface layer 2 include solid lubricants and reinforcing materials. When the adhesive reinforcing sheet 1 is used for attachment to a sliding surface of a sliding member, a solid lubricant, a reinforcing material, and the like contained in the surface layer 2 enable further improvement in sliding properties of the sliding member. An example of the solid lubricant is molybdenum disulfide. Examples of the reinforcing material include glass fillers such as glass fibers (fiberglass) and spherical glass beads, carbon fibers, and inorganic fillers such as calcium carbonate, talc, silica, alumina, and aluminum hydroxide.

When the surface layer 2 contains a solid lubricant, the lower limit of the content of the solid lubricant in the surface layer 2 is preferably 3% by mass and more preferably 8% by mass. The upper limit of the content is preferably 30% by lass, more preferably 20% by mass, and still more preferably 15% by mass. When the surface layer 2 contains a reinforcing material, the lower limit of the content of the reinforcing material in the surface layer 2 is preferably 10% by mass, and more preferably 25% by mass. The upper limit of the content is preferably 40% by mass and more preferably 35% by mass. When the content is less than the lower limit, an improvement in sliding properties due to the attachment of the adhesive reinforcing sheet 1 may become insufficient. In contrast, when the content is more than the upper limit, properties such as heat resistance may not be sufficiently provided by the attachment of the adhesive reinforcing sheet 1.

### (Intermediate Layer)

The intermediate layer 3 is laminated on one of the surfaces of the surface layer 2 and contains a metal or a super engineering plastic as a main component. The intermediate layer 3 improves the adhesive strength between the surface layer 2 and the adhesive layer 4.

The lower limit of the average thickness of the intermediate layer 3 is preferably 0.1 μm, more preferably 1 μm, still more preferably 9 μm, and particularly preferably 25 μm. The upper limit of the average thickness is preferably 2,000 μm, more preferably 500 μm, still more preferably 150 μm, and particularly preferably 60 μm. When the average thickness is less than the lower limit, the intermediate layer 3 may have insufficient strength. As a result, breakage of the intermediate layer 3 and delamination between the surface layer 2 and the intermediate layer 3 may occur. In contrast, when the average thickness is more than the upper limit, flexibility of the adhesive reinforcing sheet 1 decreases, and it may become difficult to attach the adhesive reinforcing sheet 1 to an object of attachment having a curved surface. In addition, the weight and the production cost of the adhesive reinforcing sheet 1 may increase. When the average thickness is within the above range, the strength, flexibility, lightweight properties, and production cost of the adhesive reinforcing sheet 1 are improved in a balanced manner. Thus, the adhesive reinforcing sheet 1 can be used in various applications, for example, attachment to a sliding member.

However, for example, when the object of attachment has a flat surface or the object of attachment needs to be provided with strength, the average thickness of the intermediate layer 3 of the adhesive reinforcing sheet 1 is preferably set to be larger than the average thickness described above. The lower limit of the specific average thickness of the intermediate layer 3 in such a case is preferably 500 μm, more preferably 1,000 μm, and still more preferably 1,500 μm. The upper limit of the average thickness is preferably 2,000 μm, more preferably 1,900 μm, and still more preferably 1,800 μm. When the average thickness is less than the lower limit, the object of attachment may not be provided with sufficient strength. On the other hand, when the average thickness is more than the upper limit, for example, there are concerns about a decrease in flexibility of the adhesive reinforcing sheet 1, an unnecessary increase in the weight of the adhesive reinforcing sheet 1, and an increase in the production cost of the adhesive reinforcing sheet 1.

Examples of the metal include aluminum, aluminum alloys, copper, copper alloys, iron, iron alloys such as stainless steel, and nickel. When the main component of the intermediate layer 3 is the above metal, the intermediate layer 3 may be in the form of a foil or sheet.

Examples of the super engineering plastic include polyimides (PI), polyamide-imides (PAI), polyetherimides (PEI), polyether ether ketones (PEEK), polyphenylene sulfides (PPS), polyarylates (PAR), liquid crystal polymers (LCP), polysulfones (PSF), and polyether sulfones (PES). Of these, polyimides, polyamide-imides, and combinations thereof are preferred as the super engineering plastic, and polyimides are more preferred from the viewpoint of heat resistance and the like. The super engineering plastics may be used alone or in combination of two or more thereof.

Polyimides are resins having an imide bond in the molecule thereof. For example, polyimides can be obtained by polycondensing a tetracarboxylic acid or an anhydride thereof serving as an acid component and a diamine compound serving as an amine component in a reaction solvent to prepare a polyimide precursor, and dehydrating and cyclizing the polyimide precursor by heating or the like.

Examples of the tetracarboxylic acid and the anhydride thereof include aromatic tetracarboxylic dianhydrides such as pyromellitic dianhydride, 3,3′,4,4′-benzophenonetetracarboxylic dianhydride, benzene-1,2,3,4-tetracarboxylic dianhydride, naphthalene-2,3,6,7-tetracarboxylic dianhydride, 3,3′,4,4′-diphenyl tetracarboxylic dianhydride, 2,2″,3,3″-p-terphenyltetracarboxylic dianhydride, 2,2-bis(2,3-dicarboxyphenyl)-propane dianhydride, bis(2,3-dicarboxyphenyl)ether dianhydride, bis(2,3-dicarboxyphenyl)methane dianhydride, 3,3′,4,4′-diphenylsulfonetetracarboxylic dianhydride, bis(2,3-dicarboxyphenyl)sulfone dianhydride, 1,1-bis(2,3-dicarboxyphenyl)ethane dianhydride, perylene-3,4,9,10-tetracarboxylic dianhydride, and phenanthrene-1,2,7,8-tetracarboxylic dianhydride; alicyclic acid anhydrides such as cyclopentane-1,2,3,4-tetracarboxylic dianhydride; and heterocyclic derivatives such as pyrazine-2,3,5,6-tetracarboxylic dianhydride. These tetracarboxylic acids or the anhydride thereof may be used alone or in combination of two or more thereof.

Examples of the diamine compound include aromatic diamines such as 2,2-di(p-aminophenyl)-6,6′-bisbenzoxazole, p-phenylenediamine, m-phenylenediamine, 4,4′-diaminodiphenylpropane, 2,2-bis[4-(4-aminophenoxy)phenyl]propane, 4,4′-diaminodiphenyl sulfone, 4,4′-diaminodiphenyl ether, benzidine, 4,4″-diamino-p-terphenyl, p-bis(2-methyl-4-aminopentyl)benzene, 1,5-diaminonaphthalene, 2,4-diaminotoluene, m-xylene-2,5-diamine, and m-xylylenediamine; and aliphatic diamines such as piperazine, methylenediamine, ethylenediamine, and tetramethylenediamine. These diamine components may be used alone or in combination of two or more thereof.

Polyamide-imides are resins having an amide bond and an imide bond in the molecule thereof. Polyamide-imides can be obtained by, for example, polymerization reaction between a diisocyanate compound and an acid component.

Examples of the diisocyanate compound include aromatic diisocyanate compounds such as diphenylmethane-4,4′-diisocyanate (MDI), diphenylmethane-3,3′-diisocyanate, diphenylmethane-3,4′-diisocyanate, diphenyl ether-4,4′-diisocyanate, benzophenone-4,4′-diisocyanate, and diphenyl sulfone-4,4′-diisocyanate. These diisocyanate components may be used alone or in combination of two or more thereof.

Examples of the acid component include trimellitic anhydride (TMA), 1,2,5-trimellitic acid (1,2,5-ETM), biphenyltetracarboxylic dianhydride, benzophenonetetracarboxylic dianhydride, diphenylsulfonetetracarboxylic dianhydride, oxydiphthalic dianhydride (OPDA), pyromellitic dianhydride (PMDA), and 4,4′-(2,2′-hexafluoroisopropylidene)diphthalic dianhydride. These acid components may be used alone or in combination of two or more thereof.

Of these, metals are preferable as the main component of the intermediate layer 3 from the viewpoint of the cost. From the viewpoint of the cost, ductility, heat resistance, and the ease of the formation of a chemical bond with fluororesins, aluminum, stainless steel, and iron are more preferable, and aluminum is still more preferable. Aluminum is relatively cheap and lightweight, has good ductility and heat resistance, and easily forms a chemical bond with a crosslinked fluororesin. Therefore, when the intermediate layer 3 contains aluminum as the main component, a reduction in the production cost of the adhesive reinforcing sheet 1 and an improvement in flexibility and a reduction in the weight of the intermediate layer 3 can be achieved in a balanced manner, and the effect of suppressing detachment of the surface layer 2 can be accelerated.

When the main component of the intermediate layer 3 is a metal, the lower limit of the content of the metal in the intermediate layer 3 is 90% by mass, more preferably 95% by mass, still more preferably 99% by mass, and particularly preferably 99.5% by mass. The content may be 100% by mass. That is, the intermediate layer 3 may be a metal sheet or metal foil that consists of a metal and that does not contain a binder and the like. When the content is less than the lower limit, flexibility and heat resistance of the adhesive reinforcing sheet 1 may become insufficient, and the surface layer 2 may become easily detached after attachment.

### (Peel Strength Between Surface Layer and Intermediate Layer)

The lower limit of the peel strength between the surface layer 2 and the intermediate layer 3 is preferably 20 N/cm, more preferably 40 N/cm, and still more preferably 60 N/cm. When the peel strength is less than the lower limit, the surface layer 2 may become easily detached. Herein, the term “peel strength” refers to a value measured in accordance with JIS-K6894: 2014 “Testing methods for fluoroplastic coating film on metal substrate”.

### (Adhesive Layer)

The adhesive layer 4 is laminated on a surface of the intermediate layer 3, the surface being opposite to the surface layer 2. The adhesive reinforcing sheet 1 can be attached to an object of attachment with this adhesive layer 4.

The adhesive reinforcing sheet 1 may include another layer between the adhesive layer 4 and the intermediate layer 3.

An example of the other layer is a primer layer. The other layer may be a multilayer product. An example of such a multilayer product includes a layer containing a pressure-sensitive adhesive as a main component and laminated on a surface of the intermediate layer 3, the surface being opposite to the surface layer 2, and a base layer laminated between one of the surfaces of the adhesive layer 4 and a surface of this layer, the surface being opposite to the intermediate layer 3. A commercially available double-sided tape corresponds to a product obtained by combining this multilayer product and the adhesive layer 4. The average thickness of the double-sided tape is, for example, 100 μm or more and 200 μm or less. Examples of the pressure-sensitive adhesive include the same as pressure-sensitive adhesives used for the adhesive layer 4, which will be described later. Examples of the base layer include paper, resin films, and resin sheets.

The lower limit of the average thickness of the adhesive layer 4 is not particularly limited but is, for example, 1 μm, and preferably 5 μm. The upper limit of the average thickness is not particularly limited but is, for example, 100 μm, and preferably 50 μm. When the average thickness is less than the lower limit, the adhesive strength of the adhesive reinforcing sheet 1 may decrease. In contrast, when the average thickness is more than the upper limit, the adhesive reinforcing sheet 1 may be unnecessarily thick.

Examples of the adhesive used for the adhesive layer 4 includes adhesives containing, as a main component, a polyimide, an epoxy resin, an alkyd resin, a urethane resin, a phenolic resin, a melamine resin, an acrylic resin, a polyamide, a polyamide-imide, polyethylene, polystyrene, polypropylene, a polyester, a vinyl acetate resin, rubber, or the like. Examples of the pressure-sensitive adhesive used for the adhesive layer 4 include pressure-sensitive adhesives containing, as a main component, an acrylic resin, a silicone resin, a urethane resin, or the like.

From the viewpoint of heat resistance and the like, the main component of the adhesive layer 4 is preferably an adhesive containing a polyamide-imide as a main component. The adhesives and the pressure-sensitive adhesives may be used alone or in combination of two or more thereof.

### <Method for Producing Adhesive Reinforcing Sheet>

A method for producing the adhesive reinforcing sheet 1 includes an intermediate layer lamination step of laminating an intermediate layer 3 containing a metal or a super engineering plastic as a main component on one of the surfaces of a surface layer 2 containing a fluororesin as a main component; an ionizing radiation irradiation step of, after the intermediate layer lamination step, irradiating the surface layer 2 with an ionizing radiation in a low-oxygen atmosphere at a temperature equal to or higher than a crystalline melting point of the fluororesin; and an adhesive layer lamination step of, after the ionizing radiation irradiation step, laminating an adhesive layer 4 on a surface of the intermediate layer 3, the surface being opposite to the surface layer 2.

The method for producing the adhesive reinforcing sheet 1 includes the ionizing radiation irradiation step in which the fluororesin is crosslinked and the fluororesin and the intermediate layer 3 are chemically bonded to each other. The method for producing the adhesive reinforcing sheet 1 preferably further includes, before the ionizing radiation irradiation step, a fusion bonding step of fusion-bonding the laminated surface layer 2 to the intermediate layer 3.

### (Intermediate Layer Lamination Step)

In this step, an intermediate layer 3 containing a metal or a super engineering plastic as a main component is laminated on one of the surfaces of a surface layer 2 containing a fluororesin as a main component. Examples of the method for laminating the intermediate layer 3 on the surface layer 2 include, but are not particularly limited to, a method including arranging the intermediate layer 3 and a film containing a fluororesin as a main component and serving as the surface layer 2 so as to face each other, a method including applying a fluororesin dispersion (solution in which a fluororesin powder is uniformly dispersed in a dispersion medium) to the intermediate layer 3, and subsequently drying the dispersion medium to coat the intermediate layer 3 with the surface layer 2, and a method including applying a coating liquid containing a super engineering plastic serving as the intermediate layer 3 to a film containing a fluororesin as a main component and serving as the surface layer 2.

Examples of the dispersion medium of the fluororesin dispersion include a mixed solution of water and an emulsifier, a mixed solution of water and an alcohol, a mixed solution of water and acetone, and a mixed solution of water, an alcohol, and acetone.

Before the step described above, a primer layer containing a fluororesin as a main component may be formed between the surface layer 2 and the intermediate layer 3. Before the step described above, a surface treatment may be performed on a surface of the intermediate layer 3 to be laminated with the surface layer 2. Examples of the surface treatment include surface roughening by a sandblast treatment, an etching treatment, an electrolytic polishing treatment, or the like.

In this step, when a coating liquid containing a super engineering plastic serving as the intermediate layer 3 is applied to a film containing a fluororesin as a main component and serving as the surface layer 2, a coating surface of the fluororesin film may be treated in advance with liquid ammonia or the like. When the coating surface of the fluororesin film is treated with liquid ammonia or the like, repelling of the coated super engineering plastic can be prevented, and the interlayer adhesive strength between the surface layer 2 and the intermediate layer 3 can be improved.

### (Fusion Bonding Step)

In this step, the laminated surface layer 2 is fusion-bonded to the intermediate layer 3. Through this step, the gap between the surface layer 2 and the intermediate layer 3 can be reduced. An example of the method for fusion-bonding the laminated surface layer 2 to the intermediate layer 3 is a method of heating to a temperature equal to or higher than a crystalline melting point of the fluororesin. In the case where the surface layer 2 is formed by coating with a fluororesin dispersion, fusion bonding between particles of the fluororesin can also be accelerated through this step. Note that, in this step, the heating may be performed in a low-oxygen atmosphere, and the surface layer 2 and the intermediate layer 3 may be pressed at the same time during the heating.

The heating temperature is specifically as follows, for example. When the fluororesin is FEP (crystalline melting point temperature: 270° C.), the heating temperature is 270° C. or higher. When the fluororesin is PTFE (crystalline melting point temperature: 327° C.), the heating temperature is 327° C. or higher. When the fluororesin is PFA (crystalline melting point temperature: 304° C. or higher and 310° C. or lower), the heating temperature is 310° C. or higher. The lower limit of the heating temperature is preferably a temperature 30° C. higher than the crystalline melting point temperature and more preferably a temperature 50° C. higher than the crystalline melting point temperature. The upper limit of the heating temperature is preferably a temperature 150° C. higher than the crystalline melting point temperature and more preferably a temperature 80° C. higher than the crystalline melting point temperature. The lower limit of the specific heating temperature may be appropriately changed depending on the type of fluororesin but is preferably 300° C., more preferably 320° C., and still more preferably 360° C. The upper limit of the heating temperature is preferably 480° C. and more preferably 400° C. When the heating temperature is less than the lower limit, fusion bonding of the fluororesin may become insufficient. In contrast, when the heating temperature is more than the upper limit, the fluororesin may be decomposed. The heating time is, for example, 5 minutes or more and 40 minutes or less.

The upper limit of the oxygen concentration in the low-oxygen atmosphere is preferably 100 ppm, more preferably 10 ppm, and still more preferably 5 ppm. When the oxygen concentration is more than the upper limit, decomposition of the fluororesin and oxidation of the intermediate layer 3 may occur.

### (Ionizing Radiation Irradiation Step)

In this step, the surface layer 2 is irradiated with an ionizing radiation in a low-oxygen atmosphere at a temperature equal to or higher than the crystalline melting point of the fluororesin. Regarding the irradiation direction of the ionizing radiation, from the viewpoint of suppressing shielding of the ionizing radiation by the intermediate layer 3, the ionizing radiation is preferably applied from a side of the surface layer 2 opposite to the intermediate layer 3.

The oxygen concentration in the low-oxygen atmosphere may be the same as that in the fusion bonding step described above, and thus a description of the oxygen concentration is omitted. The lower limit of the heating temperature is preferably the same as the crystalline melting point temperature, and more preferably a temperature 5° C. higher than the crystalline melting point temperature. The upper limit of the heating temperature is preferably a temperature 50° C. higher than the crystalline melting point temperature, and more preferably a temperature 20° C. higher than the crystalline melting point temperature. The lower limit of the specific heating temperature may be appropriately changed depending on the type of the fluororesin but is preferably 300° C. and more preferably 315° C. The upper limit of the heating temperature is preferably 400° C. and more preferably 350° C. By applying the ionizing radiation under the conditions described above, intermolecular crosslinking can be accelerated while suppressing scission of the main chain of the fluororesin. Furthermore, formation of the chemical bond between the fluororesin and the intermediate layer 3 can be accelerated.

Examples of the ionizing radiation include γ rays, electron beams, X rays, neutron beams, and high-energy ion beams. The lower limit of the dosage of the ionizing radiation is preferably 10 kGy, more preferably 70 kGy, and still more preferably 200 kGy. The upper limit of the dosage is preferably 2,000 kGy, more preferably 1,200 kGy, and still more preferably 400 kGy. When the dosage is less than the lower limit, the crosslinking reaction of the fluororesin may not sufficiently proceed. In contrast, when the dosage is more than the upper limit, scission of the main chain of the fluororesin may occur.

### (Adhesive Layer Lamination Step)

In this step, an adhesive layer 4 is laminated on a surface of the intermediate layer 3, the surface being opposite to the surface layer 2. The method for laminating the adhesive layer 4 on the intermediate layer 3 is not particularly limited, but an example of the method includes applying an adhesive or a pressure-sensitive adhesive to the intermediate layer 3. When the adhesive or the pressure-sensitive adhesive contains a solvent, after the application, drying may be performed by heating to a temperature of, for example, 60° C. or higher and 100° C. or lower. Alternatively, a commercially available double-sided tape or the like may be attached to the intermediate layer 3, the double-sided tape including a base layer, an adhesive layer 4 laminated on one of the surfaces of the base layer, and a layer containing a pressure-sensitive adhesive as a main component and laminated the other surface of the base layer.

### (Use)

The adhesive reinforcing sheet 1 can be suitably used for attachment to a sliding surface of a sliding member because the surface layer 2 has good abrasion resistance, good heat resistance, low tackiness, and a low coefficient of friction. In particular, when the main component of the adhesive layer 4 is a pressure-sensitive adhesive, the adhesive reinforcing sheet 1 can be easily replaced by a new one even in the case of wearing out or the like. Accordingly, such an adhesive reinforcing sheet 1 can be more suitably used as a repair member of a sliding member. Furthermore, the adhesive reinforcing sheet 1 can be suitably used for attachment to, for example, inner walls or outer walls of buildings because the surface layer 2 has good abrasion resistance and good weather resistance. In particular, the adhesive reinforcing sheet 1 can be more suitably used for attachment to, for example, inner walls of chemical plants because the surface layer 2 has good chemical resistance and good heat resistance. Furthermore, the adhesive reinforcing sheet 1 can be suitably used for attachment to, for example, surfaces of printed circuit boards or electric wires because the surface layer 2 has good insulating properties. In particular, when the intermediate layer 3 is a conductor, the adhesive reinforcing sheet 1 attached to a surface of a printed circuit board, an electric wire, or the like also functions as an electromagnetic shield. Furthermore, the adhesive reinforcing sheet 1 can be suitably used for attachment to heating surfaces of cooking equipment such as frying pans or hot plates because the surface layer 2 has good heat resistance and good abrasion resistance.

### <Advantages>

The adhesive reinforcing sheet 1 includes the surface layer 2 containing a crosslinked fluororesin as a main component. Accordingly, when the adhesive reinforcing sheet 1 is attached to an object of attachment, such as a sliding member, chemical resistance, weather resistance, abrasion resistance, and the like of the surface of the object of attachment can be improved and tackiness and the coefficient of friction can be decreased. Furthermore, since the crosslinked fluororesin is chemically bonded to the intermediate layer 3, the adhesive reinforcing sheet 1 has good interlayer adhesive strength between the surface layer 2 and the intermediate layer 3. Therefore, the surface layer 2 of the attached adhesive reinforcing sheet 1 adheres onto the object of attachment with the intermediate layer 3 and the adhesive layer 4 therebetween, and thus the surface layer 2 is unlikely to become detached. Furthermore, a metal or a super engineering plastic serving as the main component of the intermediate layer 3 can suppress deformation or the like due to heating or irradiation with an ionizing radiation during crosslinking of the fluororesin. Furthermore, even when the object of attachment is a member that has been quenched for the purpose of, for example, improving strength, a decrease in the heat-treatment effect due to tempering can be suppressed.

### Second Embodiment

### <Sliding Member>

The sliding member has a sliding surface that has the above-described adhesive reinforcing sheet attached to at least a part thereof.

Examples of a base having a sliding surface to which the adhesive reinforcing sheet is attached include, but are not particularly limited to, shafts, gaskets, pistons, and cylinders that are used in automobile engines, compressors, power generators, air blowers, and the like. From the viewpoint of making use of, for example, heat resistance of the surface layer, of these, a piston used in an automobile engine is particularly preferably used as the sliding member.

Even when this piston is a member that has been quenched for the purpose of improving strength, the adhesive reinforcing sheet can be attached while suppressing a decrease in the heat-treatment effect. In the piston, the position at which the adhesive reinforcing sheet is attached is preferably a piston skirt. Examples of the material of the base include, but are not particularly limited to, metals, resins, and ceramics. Here, when the main component of the intermediate layer of the adhesive reinforcing sheet is a metal, the main component of the intermediate layer is preferably the same as the material of the base of the sliding member. When the main component of the intermediate layer is the same as the material of the base of the sliding member, for example, corrosion due to contact between different types of metals can be suppressed. Specifically, the main component of the intermediate layer and the material of the base of the sliding member are each preferably aluminum.

### <Method for Producing Sliding Member>

An example of a method for producing the sliding member is a method including disposing the adhesive layer of the adhesive reinforcing sheet so as to face a sliding surface of a sliding member, and bringing the adhesive layer into contact with the sliding surface to attach the adhesive reinforcing sheet to the sliding surface. During the contact, thermocompression bonding may be simultaneously performed depending on the main component of the adhesive layer. The heating temperature is, for example, 150° C. or higher and 250° C. or lower. The heating time is, for example, 10 minutes or more and 120 minutes or less.

### <Advantages>

Since the adhesive reinforcing sheet is attached to at least a part of the sliding surface, the sliding member has good abrasion resistance, low tackiness, and a low coefficient of friction In addition, when the adhesive reinforcing sheet on the sliding member includes an adhesive layer containing a pressure-sensitive adhesive as a main component, the adhesive reinforcing sheet that is worn out can be easily replaced.

### Other Embodiments

It is to be understood that the embodiments disclosed herein are only illustrative and are not restrictive in all respects. The scope of the present invention is not limited to the configurations of the embodiments and is defined by the claims described below. The scope of the present invention is intended to cover all the modifications within the meaning and the scope of equivalents of the claims.

The adhesive reinforcing sheet may include another layer laminated on a surface of the adhesive layer, the surface being opposite to the intermediate layer. Specifically, the adhesive reinforcing sheet may include a release sheet laminated on a surface of the adhesive layer, the surface being opposite to the intermediate layer.

### EXAMPLES

The present invention will now be described more specifically using Examples. The present invention is not limited to the Examples described below.

Regarding the crystalline melting point of fluororesins used in the Examples, PFA has a crystalline melting point of 310° C., and PTFE has a crystalline melting point of 327° C.

### Production Example 1

A PFA sheet having an average thickness of 250 μm was laminated on an aluminum foil having an average thickness of 0.03 mm. The PFA sheet and the aluminum foil were fusion-bonded (caused to adhere to each other under heating) by heating in a thermostatic chamber in a nitrogen atmosphere having an oxygen concentration of 5 ppm or less at 380° C. for 10 minutes to prepare a laminate. An ionizing radiation was applied to the laminate from the PFA sheet side. The ionizing radiation was applied at a temperature of 320° C. at a dose of 300 kGy in a nitrogen atmosphere having an oxygen concentration of 5 ppm or less. After the irradiation with ionizing radiation, a double-sided tape (“D-202F” available from DONG YANG HIPOL CORP.) having an average thickness of 200 μm was attached to a surface of the aluminum foil, the surface being opposite to the PFA sheet, to obtain an adhesive reinforcing sheet of Production Example 1. This adhesive reinforcing sheet includes a crosslinked PFA sheet serving as a surface layer, an aluminum foil serving as an intermediate layer, and a double-sided tape serving as an adhesive layer and other layers.

### Production Example 2

An adhesive reinforcing sheet of Production Example 2 was obtained by performing the procedure as in Production Example 1 except that the irradiation with ionizing radiation was not performed. This adhesive reinforcing sheet includes an uncrosslinked PFA sheet serving as a surface layer, an aluminum foil serving as an intermediate layer, and a double-sided tape serving as an adhesive layer and other layers.

### <Evaluation of Adhesive Reinforcing Sheets of Production Examples 1 and 2_{>}

The adhesive reinforcing sheets of Production Examples 1 and 2 were each attached to an aluminum sheet serving as an object of attachment by bringing the adhesive layer into contact with the aluminum sheet to prepare test members of Production Examples 1 and 2. The abrasion resistance (limit PV value) of these test members was evaluated by a thrust abrasion test (ring-on-disc abrasion evaluation). Specifically, a metal cylinder serving as an opposing member was placed on a region of the test member to which the adhesive reinforcing sheet was attached, and the test member was rotated at a predetermined velocity (rotational velocity: V) while applying a predetermined load (surface pressure: P) to determine an abrasion state of the test member. One of the velocity (V) and the load (P) was kept constant, and the other was changed to determine the limit PV value (P·V value at which sudden abrasion occurs). When the velocity was kept constant, the velocity was set to 25 m/min. When the load was kept constant, the load was set to 10 MPa. A cylinder formed of S45C and having outer diameter/inner diameter of 11.6/7.4 was used as the opposing member. The lubrication condition was a dry (greaseless) condition. The limit PV value means that the larger the limit PV value, the better the abrasion resistance. When the value measured under the condition of the constant velocity and the value measured under the condition of the constant load were each 500 MPa·m/min or more, the abrasion resistance was evaluated as “A (Good)”. When at least one of the measured values was less than 40 MPa·m/min, the abrasion resistance was evaluated as “C (Not good)”. In a case other than the cases described above, the abrasion resistance was evaluated as “B (Fair)”. Table 1 below shows the evaluation results and the structures of the adhesive reinforcing sheets together.

TABLE 1

| | | | | | | | Abrasion resistance | | |
|---|---|---|---|---|---|---|---|---|---|
| | | | | | | | Limit PV value | | |
| | Structure | | | | | | (MPa•m/min) | | |
| | Surface layer | | Intermediate layer | | | Irradiation | Constant | Constant | |
| | | Average | | Average | Adhesive | with | velocity | load | |
| | | thickness | | thickness | layer | ionizing | (25 | (10 | |
| | Type | (μm) | Type | (μm) | Type | radiation | m/min) | MPa) | Evaluation |
| Production | Crosslinked | 250 | Aluminum | 30 | Double-sided | Performed | 125 | 50 | B |
| Example 1 | PFA | | | | tape was | | | | |
| | | | | | attached | | | | |
| Production | Uncrosslinked | 250 | Aluminum | 30 | Double-sided | Not | 5 or less | 5 or less | C |
| Example 2 | PFA | | | | tape was | performed | | | |
| | | | | | attached | | | | |

### Production Example 3

A PTFE dispersion (“EK3700C” available from Daikin Industries, Ltd.,) was applied onto an aluminum sheet having an average thickness of 1,200 μm and having been subjected to an etching treatment to form a PTFE coating film having an average thickness of 50 μm. The resulting laminate was fusion-bonded by heating in a thermostatic chamber at 390° C. for 20 minutes. After fusion bonding, an ionizing radiation was applied to the laminate from the coating film side at a temperature of 340° C. at a dose of 300 kGy in a nitrogen atmosphere having an oxygen concentration of 5 ppm or less. After the irradiation with ionizing radiation, a coating liquid containing a polyamide-imide was applied to a surface of the laminate by a spray coating method, the surface being opposite to the coating film, and dried at 80° C. for 30 minutes to obtain an adhesive reinforcing sheet of Production Example 3. This adhesive reinforcing sheet includes a crosslinked PTFE coating film serving as a surface layer, an aluminum sheet serving as an intermediate layer, and a polyamide-imide coating film serving as an adhesive layer.

### Production Example 4

An adhesive reinforcing sheet of Production Example 4 was obtained by performing the procedure as in Production Example 3 except that the irradiation with ionizing radiation was not performed. This adhesive reinforcing sheet includes an uncrosslinked PTFE coating film serving as a surface layer, an aluminum sheet serving as an intermediate layer, and a polyamide-imide coating film serving as an adhesive layer.

### Reference Example 1

A commercially available fluororesin pressure-sensitive adhesive tape (NITOFLON available from Nitto Denko Corporation) was used as an adhesive reinforcing sheet of Reference Example 1. This adhesive reinforcing sheet is a laminate having a two-layer structure and includes a layer containing uncrosslinked PTFE as a main component and a pressure-sensitive adhesive layer. The adhesive reinforcing sheet has an average thickness of the surface layer of 50 μm, an average thickness of the pressure-sensitive adhesive layer of 34 μm, and a total average thickness of 84 μm.

### <Evaluation of Adhesive Reinforcing Sheets of Production Examples 3 and 4 and Reference Example 1>

The adhesive layers of the adhesive reinforcing sheets of Production Examples 3 and 4 were each brought into contact with an aluminum sheet serving as an object of attachment. In this state, thermocompression bonding was performed at 200° C. for 60 minutes to attach the adhesive layer to the aluminum sheet. As a result, test members of Production Examples 3 and 4 were prepared. The pressure-sensitive adhesive layer of the adhesive reinforcing sheet of Reference Example 1 was brought into contact with an aluminum sheet to attach the pressure-sensitive adhesive layer to the aluminum sheet. As a result, a test member of Reference Example 1 was prepared. The abrasion resistance of these test members was evaluated by performing the procedure as in the test members of Production Examples 1 and 2. Table 2 below shows the evaluation results and the structures of the adhesive reinforcing sheets together.

TABLE 2

| | | | | | | | Abrasion resistance | | |
|---|---|---|---|---|---|---|---|---|---|
| | | | | | | | Limit PV value | | |
| | Structure | | | | | | (MPa•m/min) | | |
| | Surface layer | | Intermediate layer | | | Irradiation | Constant | Constant | |
| | | Average | | Average | Adhesive | with | velocity | load | |
| | | thickness | | thickness | layer | ionizing | (25 | (10 | |
| | Type | (μm) | Type | (μm) | Type | radiation | m/min) | MPa) | Evaluation |
| Production | Crosslinked | 50 | Aluminum | 1,200 | PAI | Performed | 1,000 | 1,200 | A |
| Example 3 | PTFE | | | | | | | | |
| Production | Uncrosslinked | 50 | Aluminum | 1,200 | PAI | Not | 10 | 10 | C |
| Example 4 | PTFE | | | | | performed | | | |
| Reference | Uncrosslinked | 50 | — | — | Pressure- | Not | 25 | 200 | C |
| Example 1 | PTFE | | | | sensitive | performed | | | |
| | | | | | adhesive | | | | |
| | | | | | layer | | | | |

As shown in the results in Tables 1 and 2, when the adhesive reinforcing sheets of Production Examples 1 and 3 were attached objects, abrasion resistance could be improved. In contrast, even when the adhesive reinforcing sheets of Production Examples 2 and 4 and Reference Example 1 were attached objects, abrasion resistance could not be sufficiently improved. Accordingly, it is believed that, in the above adhesive reinforcing sheets, the surface layer containing a fluororesin as a main component can be attached to an object of attachment easily and reliably, and abrasion resistance and the like of the surface of the resulting object of attachment can be improved.

In addition, the adhesive reinforcing sheet of Production Example 1 includes an intermediate layer having a smaller thickness than the intermediate layer of the adhesive reinforcing sheet of Production Example 3. Accordingly, the adhesive reinforcing sheet of Production Example 1 includes an intermediate layer having a low material cost, is lightweight, and has good flexibility. Thus, the adhesive reinforcing sheet of Production Example 1 can be used in various applications.

### Production Example 5

A fluorine-based primer was applied to one surface of a stainless steel (SUS304) sheet having an average thickness of 42 μm so as to have an average thickness of 6 μm, and was then dried in a thermostatic chamber at 150° C. for 30 minutes.

After the drying, a PFA dispersion was applied by a DIP method onto the fluorine-based primer on the stainless steel sheet to form a PFA coating film having an average thickness of 12 μm. The resulting laminate was fusion-bonded by baking in a thermostatic chamber at 360° C. for 20 minutes in a nitrogen atmosphere having an oxygen concentration of 5 ppm or less.

Subsequently, an ionizing radiation was applied to the laminate from the coating film side at a temperature of 340° C. at a dose of 300 kGy in a nitrogen atmosphere having an oxygen concentration of 5 ppm or less. After the irradiation with ionizing radiation, a coating liquid containing a polyamide-imide was applied to a surface of the laminate by a spray coating method, the surface being opposite to the coating film, so as to have an average thickness of 10 μm and dried in a thermostatic chamber at 80° C. for 30 minutes to obtain an adhesive reinforcing sheet of Production Example 5. This adhesive reinforcing sheet includes a crosslinked PFA coating film and a fluorine-based primer that serve as a surface layer, a stainless steel sheet serving as an intermediate layer, and a polyamide-imide coating film serving as an adhesive layer.

### Production Example 6

An adhesive reinforcing sheet of Production Example 6 was obtained by performing the procedure as in Production Example 5 except that the irradiation with ionizing radiation was not performed. This adhesive reinforcing sheet includes an uncrosslinked PFA coating film and a fluorine-based primer that serve as a surface layer, a stainless steel sheet serving as an intermediate layer, and a polyamide-imide coating film serving as an adhesive layer.

### <Evaluation of Adhesive Reinforcing Sheets of Production Examples 5 and 6>

The adhesive layers of the adhesive reinforcing sheets of Production Examples 5 and 6 were each brought into contact with an aluminum sheet serving as an object of attachment. In this state, thermocompression bonding was performed at 200° C. for 60 minutes to attach the adhesive layer to the aluminum sheet. As a result, test members of Production Examples 5 and 6 were prepared. The thrust abrasion test (ring-on-disc abrasion evaluation) was conducted under the same conditions as those for the test members of Production Examples 1 and 2 except that the load was changed while the rotational velocity was kept constant at 1,800 rpm. Durability was evaluated by measuring a load (kgf) at break of the surface layer. The load at break of the surface layer means that the larger the value of the load at break, the better the durability. When the load at break was 50 kgf or more, the durability was evaluated as “A (Good)”. When the load at break was less than 50 kgf, the durability was evaluated as “B (Not good)”. Table 3 below shows the evaluation results and the structures of the adhesive reinforcing sheets together.

TABLE 3

| | | | | | | | | Durability | |
|---|---|---|---|---|---|---|---|---|---|
| | | | | | | | | Load | |
| | | | | | | | | at | |
| | Structure | | | | | | | break | |
| | Surface layer | | Intermediate layer | | Adhesive layer | | Irradiation | of | |
| | | Average | | with | | Average | | surface | |
| | | thickness | | thickness | | thickness | ionizing | layer | |
| | Type | (μm) | Type | (μm) | Type | (μm) | radiation | (kgf) | Evaluation |
| Production | Crosslinked | 12 | SUS304 | 42 | PAI | 10 | Performed | 95 or | A |
| Example 5 | PFA | | | | | | | more | |
| | Primer | 6 | | | | | | | |
| Production | Uncrosslinked | 12 | SUS304 | 42 | PAI | 10 | Not | 5 or | B |
| Example 6 | PFA | | | | | | performed | less | |
| | Primer | 6 | | | | | | | |

As shown in the results in Table 3, the adhesive reinforcing sheet of Production Example 5 had durability higher than the adhesive reinforcing sheet of Production Example 6. Accordingly, it is believed that, in the above adhesive reinforcing sheet, also in the case where a stainless steel is used as the intermediate layer, the surface layer containing a fluororesin as a main component can be attached to an object of attachment easily and reliably, and abrasion resistance and the like of the surface of the resulting object of attachment can be improved.

### Production Example 7

In order to prevent repelling during the formation of an intermediate layer and to improve adhesiveness, one of the surfaces of a PTFE skived sheet (available from Nippon Valqua Industries, Ltd.) having an average thickness of 180 μm was treated with liquid ammonia. A coating liquid containing a polyamide-imide was applied to the surface of the PTFE skived sheet, the surface having been subjected to the ammonia treatment, by a spin-coating method to form a polyamide-imide coating film having an average thickness of 10 μm. After the formation of the coating film, drying was performed in a thermostatic chamber at 80° C. for 30 minutes. After the drying, an ionizing radiation was applied to the resulting laminate from the PTFE skived sheet side at a temperature of 340° C. at a dose of 300 kGy in a nitrogen atmosphere having an oxygen concentration of 5 ppm or less. After the irradiation with ionizing radiation, a coating liquid containing a polyamide-imide was applied to a surface of the laminate by a spray coating method, the surface being opposite to the PTFE skived sheet, so as to have an average thickness of 10 μm and dried in a thermostatic chamber at 80° C. for 30 minutes to obtain an adhesive reinforcing sheet of Production Example 7. This adhesive reinforcing sheet includes a crosslinked PTFE skived sheet serving as a surface layer, a polyamide-imide coating film serving as an intermediate layer, and a polyamide-imide coating film serving as an adhesive layer. Note that, in the adhesive reinforcing sheet of Production Example 7, since the adhesive strength of the polyamide-imide coating film serving as the intermediate layer is decreased by the irradiation with ionizing radiation, the polyamide-imide coating film serving as the adhesive layer is laminated. Accordingly, the intermediate layer and the adhesive layer are each a polyamide-imide coating film, but the polyamide-imide coating films have different functions.

### Production Example 8

An adhesive reinforcing sheet of Production Example 8 was obtained by performing the procedure as in Production Example 7 except that the irradiation with ionizing radiation was not performed, and a coating liquid containing a polyamide-imide was applied only once. This adhesive reinforcing sheet includes an uncrosslinked PTFE skived sheet serving as a surface layer, and a polyamide-imide coating film serving as an adhesive layer.

The adhesive layers of the adhesive reinforcing sheets of Production Examples 7 and 8 were each brought into contact with an aluminum sheet serving as an object of attachment. In this state, thermocompression bonding was performed at 200° C. for 60 minutes to attach the adhesive layer to the aluminum sheet. As a result, test members of Production Examples 7 and 8 were prepared. The abrasion resistance of these test members was evaluated by performing the procedure as in the test members of Production Examples 1 and 2. Table 4 below shows the evaluation results and the structures of the adhesive reinforcing sheets together.

TABLE 4

| | | | | | | | | Abrasion resistance | | |
|---|---|---|---|---|---|---|---|---|---|---|
| | | | | | | | | Limit PV value | | |
| | Structure | | | | | | | (MPa•m/min) | | |
| | Surface layer | | Intermediate layer | | Adhesive layer | | Irradiation | Constant | Constant | |
| | | Average | | Average | | Average | with | velocity | load | |
| | | thickness | | thickness | | thickness | ionizing | (25 | (10 | |
| | Type | (μm) | Type | (μm) | Type | (μm) | radiation | m/min) | MPa) | Evaluation |
| Production | Crosslinked | 180 | PAI | 10 | PAI | 10 | Performed | 1,000 | 1,100 | A |
| Example 7 | PTFE | | | | | | | | | |
| Production | Uncrosslinked | 180 | — | — | PAI | 10 | Not | 10 | 10 | C |
| Example 8 | PTFE | | | | | | performed | | | |

As shown in the results in Table 4, the adhesive reinforcing sheet of Production Example 7 had abrasion resistance higher than the adhesive reinforcing sheet of Production Example 8. Accordingly, it is believed that, in the above adhesive reinforcing sheet, also in the case where a polyamide-imide, which is a super engineering plastic, is used as the intermediate layer, the surface layer containing a fluororesin as a main component can be attached to an object of attachment easily and reliably, and abrasion resistance and the like of the surface of the resulting object of attachment can be improved.

In addition, since the adhesive reinforcing sheet of Production Example 7 includes an intermediate layer having a small thickness of 10 μm, it is believed that the adhesive reinforcing sheet of Production Example 7 can be suitably used for attachment to a curved surface of a piston skirt or the like.

### INDUSTRIAL APPLICABILITY

An adhesive reinforcing sheet according to an embodiment of the present invention and a method for producing the adhesive reinforcing sheet can provide an adhesive reinforcing sheet with which a surface layer containing a crosslinked fluororesin as a main component can be easily and reliably attached to an object of attachment.

A sliding member according to another embodiment of the present invention has a surface layer that contains a fluororesin as a main component and that is unlikely to become detached, and can be produced at a low cost.

### REFERENCE SIGNS LIST

1 adhesive reinforcing sheet
2 surface layer
3 intermediate layer
4 adhesive layer

1. An adhesive reinforcing sheet comprising:
a surface layer containing a crosslinked fluororesin as a main component;
an intermediate layer laminated on one of surfaces of the surface layer and containing a metal or a super engineering plastic as a main component; and
an adhesive layer laminated on a surface of the intermediate layer, the surface being opposite to the surface layer,
wherein the crosslinked fluororesin is chemically bonded to the intermediate layer.

2. The adhesive reinforcing sheet according to claim 1,
wherein the intermediate layer contains a metal as the main component, and
the metal is aluminum, stainless steel, or iron.

3. The adhesive reinforcing sheet according to claim 1,
wherein the intermediate layer contains a super engineering plastic as the main component, and
the super engineering plastic is a polyimide, a polyamide-imide, or a combination of a polyimide and a polyamide-imide.

4. The adhesive reinforcing sheet according to claim 1,
wherein the surface layer has an average thickness of 10 μm or more and 1,500 μm or less, and
the intermediate layer has an average thickness of 0.1 μm or more and 2,000 μm or less.

5. The adhesive reinforcing sheet according to claim 1, the adhesive reinforcing sheet being used for attachment to a sliding surface of a sliding member.

6. A sliding member having a sliding surface that has the adhesive reinforcing sheet according to claim 5, the adhesive reinforcing sheet being attached to at least a part of the sliding surface.

7. A method for producing an adhesive reinforcing sheet, the method comprising:
an intermediate layer lamination step of laminating an intermediate layer containing a metal or a super engineering plastic as a main component on one of surfaces of a surface layer containing a fluororesin as a main component;
an ionizing radiation irradiation step of, after the intermediate layer lamination step, irradiating the surface layer with an ionizing radiation in a low-oxygen atmosphere at a temperature equal to or higher than a crystalline melting point of the fluororesin; and
an adhesive layer lamination step of, after the ionizing radiation irradiation step, laminating an adhesive layer on a surface of the intermediate layer, the surface being opposite to the surface layer,
wherein in the ionizing radiation irradiation step, the fluororesin is crosslinked, and the fluororesin and the intermediate layer are chemically bonded to each other.
